(19) United States
(12) Patent Application Publication
(10) Pub. No.: US 2004/0181510 A1
(43) Pub. Date: Sep. 16, 2004

(54) System and method for cooperative database acceleration

(76) Inventor: Cary A. Jardin, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/807,816

(22) Filed: Mar. 23, 2004

Related U.S. Application Data
(63) Continuation-in-part of application No. 10/345,811, filed on Jan. 16, 2003.
(63) Continuation-in-part of application No. 10/345,504, filed on Jan. 16, 2003.

(51) Int. Cl. G06F 12/00; G06F 17/30; G06F 7/00

(52) U.S. Cl. 707/2

(57) ABSTRACT

Embodiments of the systems and methods provide the reliable and persistent data storage of traditional database systems combined with the superior performance of high-speed volatile memory databases. The database server, for example, a SQL server, communicates with a computer data storage device, for example, a computer hard disk drive or other persistent storage device, for permanent storage and maintenance of database data entries or records. The database server additionally communicates with a volatile, main memory database system capable of high-speed performance. The database server can use the persistent database system in combination with the enhanced performance volatile database system to provide both reliability and substantially accelerated database performance.

### RELATED APPLICATIONS

This application is a continuation-in-part of, and claims priority to, U.S. patent application Ser. No. 10/345,811, filed Jan. 16, 2003 and titled “SYSTEM AND METHOD FOR DISTRIBUTED DATABASE PROCESSING IN A CLUSTERED ENVIRONMENT,” and U.S. patent application Ser. No. 10/345,504, filed Jan. 16, 2003 and titled “SYSTEM AND METHOD FOR COOPERATIVE DATABASE ACCELERATION,” which are hereby incorporated by reference in their entireties. This application is related to U.S. Patent Application No. ______ (Attorney Docket No. XP.002CP1) titled “SYSTEM AND METHOD FOR DISTRIBUTED PROCESSING IN A NODE ENVIRONMENT,” U.S. Patent Application No. ______ (Attorney Docket No. XP.002CP2) titled “SYSTEM AND METHOD FOR CONTROLLING PROCESSING IN A DISTRIBUTED SYSTEM,” U.S. Patent Application No. ______ (Attorney Docket No. XP.002CP3) titled “SYSTEM AND METHOD FOR GENERATING AND PROCESSING RESULTS DATA IN A DISTRIBUTED SYSTEM,” and U.S. Patent Application No. ______ (Attorney Docket No. XP.002CP4) titled “SHARED MEMORY ROUTER SYSTEM AND METHOD FOR NODE COMMUNICATION IN A DISTRIBUTED SYSTEM,” which are filed on even date herewith and are all hereby incorporated by reference in their entireties.

### BACKGROUND OF THE INVENTION

1. Field of the Invention

The present invention generally relates to computer data storage systems. More particularly, the invention relates to systems and methods for increasing the performance of computer database systems.

2. Description of the Related Technology

Database systems have become a central and critical element of business infrastructure with the development and widespread use of computer systems and electronic data. Businesses typically rely on computer databases to be the safe harbor for storage and retrieval of very large amounts of vital information. The speed and storage capacities of computer systems have grown exponentially over the years, as has the need for larger and faster database systems.

A database (DB) is a collection of information organized in such a way that a computer program can quickly select desired pieces of data. Traditional databases are organized by fields, records and files. A field is a single piece of information, a record is one complete set of fields, and a table or file is a collection of records. For example, a telephone book is analogous to a table or file. It contains a list of records that is analogous to the entries of people or businesses in the phone book, each record consisting of three fields: name, address, and telephone number.

In its simplest form, a database is a repository for the storage and retrieval of information. The early database systems simply provided batch input command data for programs, and stored the programmatic output. As computing technologies have advanced greatly over the years, so too have database systems progressed from an internal function supporting the execution of computer programs to complex and powerful stand-alone data storage systems. Client applications executing on computer systems can connect to or communicate with the database system via a network, or by other programmatic means, to store and retrieve data.

A database management system (DBMS) can be used to access information in a database. The DBMS is a collection of programs that enables the entry, organization and selection of data in a database. There are many different types of DBMSs, ranging from small systems that run on personal computers to very large systems that run on mainframe computers or serve the data storage and retrieval needs of many computers connected to a computer network. The term “database” is often used as shorthand to refer to a “database management system.”

While database system applications are numerous and various, following are several examples:

computerized library systems;

automated teller machines and bank account data;

customer contact and account information;

flight reservation systems; and

computerized parts inventory systems.

From a technical standpoint, DBMSs can vary widely. For example, a DBMS can organize information internally in relational, network, flat, and hierarchical manners. The internal organization can affect how quickly and flexibly information can be extracted from the database system. A relational database is one which stores data in two or more tables and enables the user to define relationships between the tables. The link between the tables is based on field values common to both tables.

Requests for information from a database are typically presented in the form of a query, which is essentially a stylized or structured question. For example, the following query requests all records from the current database table in which the NAME field is SMITH and the AGE field is greater than 35.

SELECT ALL WHERE NAME=“SMITH” AND AGE>35

The set of rules or standards for constructing queries is generally referred to as a query language. Different DBMSs support different query languages, although there is a semi-standardized query language called structured query language (SQL). In addition, more sophisticated languages for managing database systems are referred to as fourth generation languages, or 4GLs for short.

SQL is used to communicate with a database. SQL is the ANSI (American National Standards Institute) standard language for relational database management systems. SQL statements are used to perform tasks such as update data on a database or retrieve data from a database. Although there are different dialects of SQL, it is nevertheless the closest thing to a standard query language that currently exists. Some examples of relational database management systems that use SQL include the following: Oracle, Sybase, Microsoft SQL Server, Access, and Ingres. Although most database systems use SQL, many also have their own additional proprietary extensions that are usually only used on that system. However, the standard SQL commands such as “Select,” “Insert,” “Update,” “Delete,” “Create,” and “Drop” can be used to accomplish most operations that the user needs to do with a database.

Historically, SQL has been the most widely used query language for database management systems running on minicomputers and mainframe computers. Increasingly, SQL is also being supported by and used on personal computer (PC) database systems, as it supports distributed databases. Distributed databases are databases that are spread out over multiple computer systems and connected by a communication link such as a computer network. Distributed databases enable several users on a network such as a local area network (LAN) to access the same database simultaneously.

The information retrieved from a database query can be presented in a variety of formats. Most DBMSs include a report writing program that enables the output of data in the form of a report. Many DBMSs also include a graphics component that enables the output of information in the form of graphs and charts.

However, existing database systems are typically the bottleneck of computer systems, and the ever-growing power and speed of modem computing systems exacerbate this problem as computer processors are able to receive and process data ever more quickly. Therefore, what is needed is an accelerated database system that provides both long-term persistent (reliable and continuous) data storage and very high-speed data retrieval.

### SUMMARY OF CERTAIN INVENTIVE ASPECTS

The systems and methods of the invention have many features, no single one of which is solely responsible for its desirable attributes. Without limiting the scope of the invention as expressed by the claims that follow, its more prominent features will now be discussed briefly. After considering this discussion, and particularly after reading the section entitled “Detailed Description of Certain Embodiments,” one will understand how the features of the system and methods provide advantages over traditional systems.

Embodiments of the present invention provide the reliability and persistent storage of traditional database systems with the superior performance of high-speed volatile memory databases. Embodiments of the systems and methods include storing and retrieving a table of data from an accelerated database system, including storing a table of data on a persistent storage device, which is configured for continuous storage of the table of data. Additionally included is storing the table of data concurrently on a volatile storage database system. The volatile storage database system is configured for storage and high-speed retrieval of the table of data, and receiving a database write command and sending a corresponding write command to the persistent storage device and to the volatile storage database system. Also included is receiving a database read command requesting data and retrieving the requested data from the volatile storage database system.

Additionally, this can also include distributing the database write command among a plurality of processors of the volatile storage database system. Also included is returning results data from the database read command and generating the database read command and the database write command in response to a user action and transmitting the database read command and the database write command via a network.

Embodiments of the systems and methods can further include distributing a database write command to a persistent storage device and to a volatile storage database system, and distributing a database read command to the volatile storage database system. This additionally includes receiving a database command via a network, wherein the database command includes a read command and a write command, and wherein the read command and the write command include a database table name. Also included is transmitting data related to the database command over the network and receiving the write command. This further includes generating a trigger in response to the write command, wherein the trigger includes execution of instructions that cause a persistent storage device and a volatile storage database system to be updated according to the database table name and the data related to the database command. Additionally included is receiving the read command and directing the read command to the volatile storage database system.

### BRIEF DESCRIPTION OF THE DRAWINGS

The above and other aspects, features and advantages of the invention will be better understood by referring to the following detailed description, which should be read in conjunction with the accompanying drawings. These drawings and the associated description are provided to illustrate certain embodiments of the invention, and not to limit the scope of the invention.

FIG. 1 is a block diagram illustrating one example of a computer system architecture in which embodiments of the accelerated database system operate.

FIG. 2 is a block diagram illustrating certain components or modules of the database server system within the accelerated database system shown in FIG. 1.

FIG. 3 is a block diagram illustrating components or modules of the nodes of the volatile storage database shown in FIG. 1.

FIG. 4 is a flowchart illustrating a database command process as performed by the database command processing module shown in FIG. 2.

FIG. 5 is a flowchart illustrating a database write command process as performed by the database command processing module shown in FIG. 2.

FIG. 6 is a flowchart illustrating a database read command process as performed by the database command processing module shown in FIG. 2.

FIG. 7 is a flowchart illustrating a commit/rollback process as performed by the commit/rollback processing module shown in FIG. 2.

### DETAILED DESCRIPTION OF CERTAIN EMBODIMENTS

The following detailed description is directed to certain specific embodiments of the invention. However, the invention can be embodied in a multitude of different ways as defined and covered by the claims. The scope of the invention is to be determined with reference to the appended claims. In this description, reference is made to the drawings wherein like parts are designated with like numerals throughout.

The accelerated database system described herein can be implemented in different embodiments as various modules as discussed in detail below. The components or modules can be implemented as, but are not limited to, software, hardware or firmware components, or any combination of such components, that perform certain functions, steps or tasks as described herein. Thus, for example, a component or module may include software components, firmware, microcode, circuitry, an application specific integrated circuit (ASIC), and may further include data, databases, data structures, tables, arrays, and variables. In the case of a software embodiment, each of the modules can be separately compiled and linked into a single executable program, or may be run in an interpretive manner, such as a macro. The functions, steps or tasks associated with each of the modules may be redistributed to one of the other modules, combined together in a single module, or made available in, for example, a shareable dynamic link library. Furthermore, the functionality provided for in the components or modules may be combined into fewer components, modules, or databases or further separated into additional components, modules, or databases. Additionally, the components or modules may be implemented to execute on one or more computers.

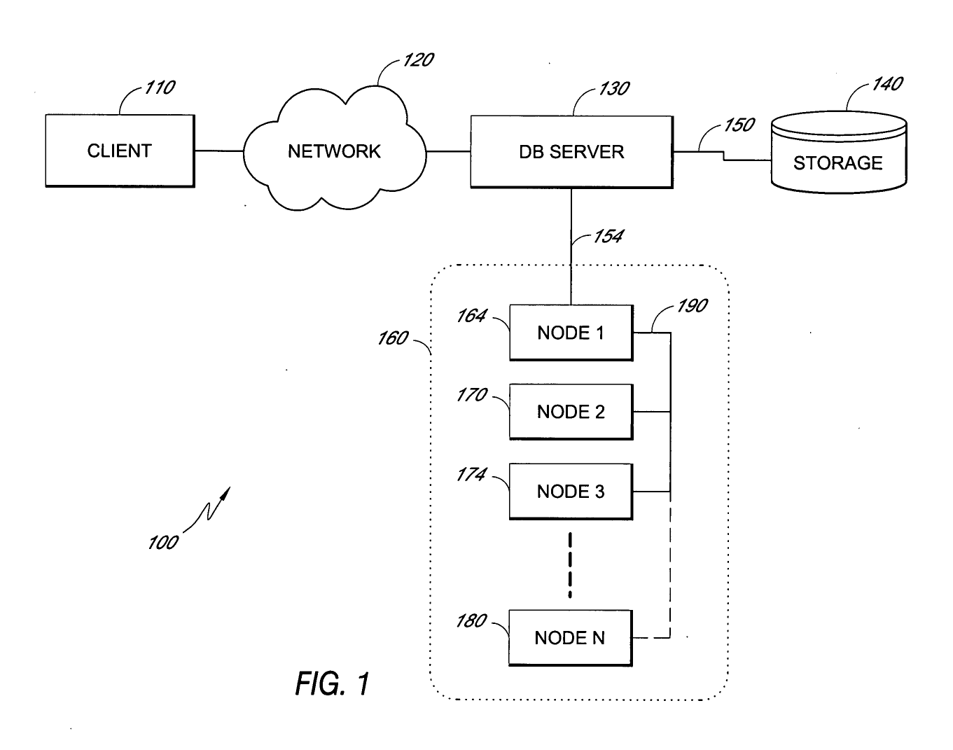

Referring to the figures, FIG. 1 is a block diagram illustrating one example of a database system 100. The database system 100 includes an accelerated database system 105, which in turn includes a database (DB) server 130 that is connected to a persistent storage device 140 and a volatile storage database system 160 as shown in FIG. 1. The accelerated database system 105 can store data reliably and continuously for long periods of time on the persistent storage device 140, and simultaneously store data for fast retrieval on the volatile storage database system 160. In some embodiments, the DB server 130 stores data both on the persistent storage device 140 and on the volatile storage database system 160, such that the data stored on the databases are copies of one another. In this way, the accelerated database system 105 stores data reliably and retrieves data very rapidly.

The database system 100 can include a client computer system 110. The client computer system 110 can be one or more computers and associated input devices. The client computer system 110 is used by clients or users of the database system 100 to access the accelerated database system 105. The client typically accesses the accelerated database system 105 by entering database commands and viewing database information in a logical and easy to use manner via a graphical user interface (GUI) that executes on the client computer system 110. The client computer system 110 can also employ other types of user interfaces, such as scripting language files or command line interfaces.

The DB server 130 can be implemented in a computer or a computer system. For example, such servers are available from Oracle and Microsoft. The DB server 130 receives database commands, for example, read and write commands, transmitted by the client computer system 110 via a network 120. The DB server 130 also determines whether to send the database commands to the persistent storage device 140, or to the volatile storage database system 160, or to both. The DB server 130 additionally receives responses from the database read commands, for example, result data from a database query command. The DB server 130 can be a SQL server that conforms or approximately conforms to the SQL standard for database query language. The database commands can be initiated through user input or other user actions on the client computer system 110, or programmatically generated by an application running on the client computer system 110.

The network 120 is represented in FIG. 1 as a cloud-shaped symbol to illustrate that a multitude of network configurations are possible and that the client computer system 110 and the DB server 130 can be indirectly connected via multiple server computers and network connections (not shown). Alternatively, the DB server 130 can be directly connected to the client computer system 110, or the DB server 130 can be included within the client computer system 110, in which case the network 120 is not needed.

The DB server 130 communicates with the persistent storage device 140 via a communication link 150. The communication link 150 can be a direct connection or a network connection. Characteristics of embodiments of the persistent storage device 140 include the capability to store data, for example, database entries or records, through cycles in power (e.g., power on/power off transitions) and for long periods of time in a reliable way. The persistent storage device 140 can be, for example, one or more computer hard disk drives, tape drives, or other long-term storage devices and combinations of the foregoing.

The accelerated database system 105 further includes the volatile storage database system 160 that communicates with the DB server 130 via a communication link 154. The volatile storage database system 160 provides database storage of information and very high-speed data retrieval. The volatile storage database system 160 can be a SQL compliant database. In one embodiment, the volatile storage database system 160 is a processor with a main memory. Alternatively, multiple processors, each with a main memory, can be used. The memory or data storage of the volatile storage database can be, for example, solid state memory such as random access memory (RAM). A characteristic of such a volatile memory is loss of stored data when power is removed. The communication link 154 can be an Ethernet network connection that conforms to the TCP/IP network protocol, for example, the Internet, a local area network (LAN), a wide area network (WAN), an Intranet, or other network links and protocols.

As shown in FIG. 1, the volatile storage database system 160 can include multiple nodes 164, 170, 174, 180 connected via an inter-nodal communication link 190. Each node can store a portion of the database information, for example, a substantially equal portion. High-speed retrieval can be improved when the nodes 164, 170, 174, 180 process database read commands in a parallel manner on the portion of the database stored at each of the nodes. The inter-nodal communication link 190 transfers data between the nodes 164, 170, 174, 180, and is preferably a high throughput, low latency communication interface link. The inter-nodal communication link 190 can be a commercially available communication link, or a custom-built, proprietary communication link. As designated by the label “NODE N” for the node 180, any number of nodes can be utilized, typically determined by the storage size and performance requirements of the particular database system. Alternatively, the volatile storage database system 160 can include only a single node, in which case the inter-nodal communication link 190 is not needed.

In embodiments having more than one node, one of the nodes communicates directly with the DB server 130 via the communication link 154. In this case, as shown in FIG. 1, the node 164 is referred to as the primary node. The nodes 170, 174, 180 in FIG. 1, referred to as secondary nodes, are not in direct communication with the DB server 130, but communicate with the other nodes and with the primary node 164 via the inter-nodal communication link 190. In other embodiments, multiple nodes 164, 170, 174, 180 are connected to the DB server 130 via the communication link 154, up to a maximum of all the nodes. The internal components and functionality of the nodes are described in greater detail below.

The systems and methods described herein can establish a master and slave database relationship between the persistent storage device 140 and the volatile storage database system 160. For example, the user can define the persistent storage device 140 to be the master database and the volatile storage database system 160 to be the slave database. The user can define this master/slave relationship if the user has existing applications that utilize an existing DB server. In this way, the user can enhance their existing persistent storage device database system through the use of a slave volatile database system.

One way of achieving this master/slave configuration is to utilize a master database system (DB server 130 and persistent storage device 140) with what is referred to as heterogeneous table support. This refers to the master database being able to access information not stored in local or native format. In this example, the information not stored in local or native format is stored in the volatile storage database system 160. Another way to achieve the master/slave database relationship is to modify the DB server 130 to accept a prefix for database table names not locally or natively stored and to obtain the requested information associated with the prefix from the specified location. In ANSI SQL, this could be achieved by fully specifying the name for each table, for example, “data_source.database_name.table_name.” The master database can conform to one format, and the slave database can conform to another format.

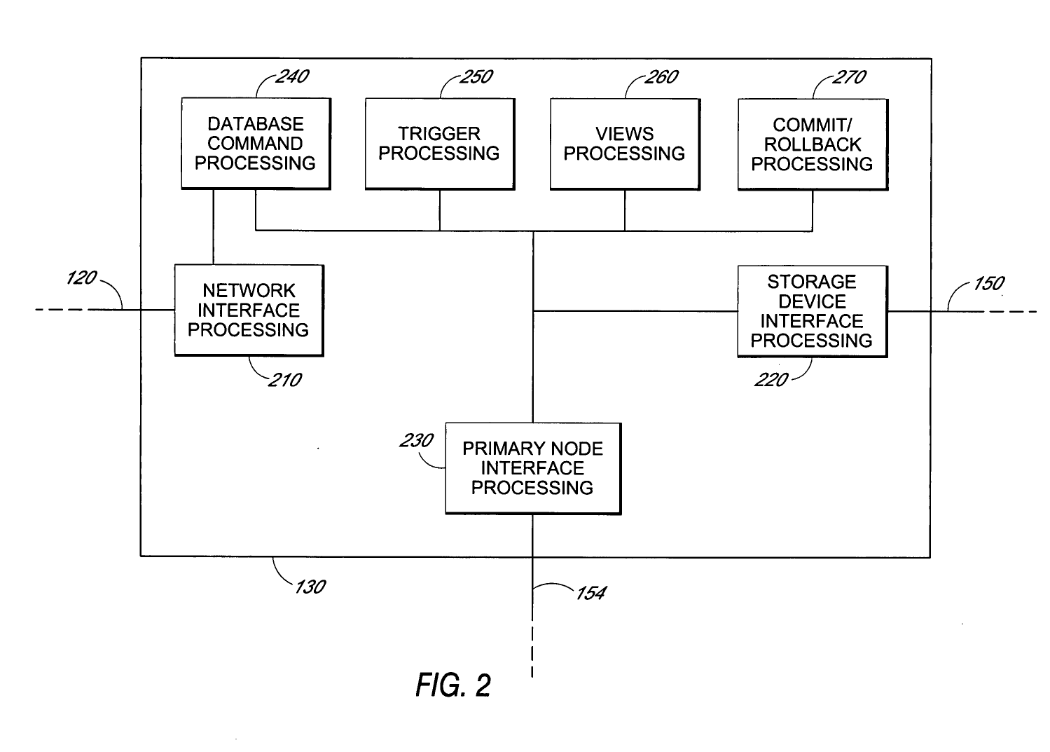

FIG. 2 is a block diagram illustrating certain components or modules of the DB server 130 within the database system 100 shown in FIG. 1. The DB server 130 includes a network interface processing module 210 connected via the network 120 to the client computer system 110 (not shown). The network interface processing module 210 transmits and receives data between the DB server 130 and the client computer system 110 in conformance with the applicable network protocol, for example, TCP/IP. The DB server 130 additionally includes a storage device interface processing module 220 connected via the communication link 150 to the persistent storage device 140 (not shown). The storage device interface processing module 220 receives and transmits data between the DB server 130 and the persistent storage device 140. Additionally, the DB server 130 includes a primary node interface processing module 230 connected via the communication link 154 to the primary node 164 of the volatile storage database system 160 (not shown). The primary node interface processing module 230 transmits and receives data between the DB server 130 and the primary node 164.

The DB server 130 shown in FIG. 2 further includes a database command processing module 240. The database command processing module 240 receives and processes database commands from the network interface processing module 210. The database commands can be in various selected database command query languages, for example, a standardized query language such as SQL, SQL with additional proprietary extensions, or a full proprietary query language.

The DB server 130 includes a trigger processing module 250 for detecting the occurrence of predetermined events and executing specified instructions when the corresponding event is detected. The detection of an event and the execution of the associated instructions are referred to as a trigger. The trigger processing module 250 can maintain coherency between the persistent storage device 140 and the volatile storage database system 160 by causing a standard SQL database write command to write the data to the two databases. In certain embodiments, the trigger processing module 250 detects database write commands and executes instructions which direct the write commands to both the persistent storage device 140 and the volatile storage database system 160. While this is one example of how triggers can be implemented, the users, operators or designers of the accelerated database system 105 can control what actions are taken in response to particular events by entering or modifying the instructions associated with the trigger.

Alternatively, the trigger processing module 250 can execute database write commands in a batch processing mode. Batch processing refers to the queuing up of multiple database commands that execute without user interaction at a later time. Standard SQL protocol does not support either batch or incremental updates. The trigger processing module 250 executing on the DB server 130 performs batch processing by implementing standard interface procedures that are included in standard SQL protocol. Batch processing can be utilized for write commands to both the persistent storage device 140 and the volatile storage database system 160. One example of batch processing involves simply writing to a disk file or database table the state change information for carrying out the write command. When the trigger processing module 250 executes the write commands as a batch process, the trigger processing module 250 retrieves the information from the disk file or database table and individually executing each state change specified in the disk file or database table.

The DB server 130 additionally includes a views processing module 260. A view refers to a SQL capability allowing for an alias or abstraction of a database table name that permits indirection between the table name and the actual table contents. The views processing module 260 allows for redirection of database read commands, such that read commands that originally were directed to the persistent storage device 140 can be redirected to the faster volatile storage database system 160 by merely changing a views table. The views table maps a database table name to a particular database. In this way, existing database applications that only store data on a single type of database, for example, a persistent database, can be migrated to the accelerated database system 105 with minimal effort involving modification of the views table.

Alternatively, the views processing module 260 accepts a prefix appended to the table name and determines the destination database storage device or devices according to the prefix by reference to the views table. The views processing module 260 can determine the destination database by maintaining the views table that correlates certain prefixes or table names to certain database devices. In this example, the views processing module 260 performs a look-up function on the views table and receives the corresponding destination database storage device. Thus, the views processing module 260 enables applications and programs written for traditional database systems to operate on the accelerated database system 105 by modifying just the views table. In other words, the existing applications and programs do not have to be modified, which typically results in a significant savings in time and cost.

The DB server 130 additionally includes a commit/rollback processing module 270. Commit/rollback processing is also referred to as two phase commit processing. Two phase commit processing can be used by database systems in the situation where multiple data updates may occur simultaneously or at multiple databases within a distributed database system. By utilizing two phase commit processing, the commit/rollback processing module 270 maintains data integrity and accuracy within database systems through synchronized locking and updating of all segments of the commit/rollback process. Several examples of applications that commonly implement two phase commit protocols are hotel reservation systems, airline reservation systems, stock market transactions, banking applications, and credit card systems.

Upon initiation of a two phase commit process, the commit/rollback processing module 270 locks the affected database record or records, thereby marking the record as unavailable to be viewed, modified or otherwise accessed by any user other than the user that initiated the lock. The records remain locked for the duration of the two phase commit process, which can be completed when the commit/rollback processing module 270 executes a rollback operation or a commit operation. If the user elects to abort the two phase commit process after the lock has been established but before committing to the transaction, the user requests a rollback.

The commit/rollback processing module 270, upon receiving the rollback request, sends a rollback command to the primary node 164 of the volatile storage database system 160 and to the persistent storage device 140. In the embodiment in which the DB server 130 is a SQL server, the SQL server manages the commit and rollback operations to the persistent storage device 140. However, in one example the SQL server does not manage the commit and rollback operations to the volatile storage database system 160. In one embodiment, the DB server 130 manages the lock state, although alternatively the primary node 164 can manage the lock state for the volatile storage database system 160. Each node keeps a list of all changes made to the portion of the database records stored on that node that is changed during the lock state. If a rollback request is received, each node performs the rollback or undo function by backing out each change to the database as detailed by the list of changes and deleting the list. If, instead, a commit request is received, each node deletes the list of changes and the primary node removes the lock state.

Thus, the rollback operation can be thought of as an undo operation, as any and all changes entered by the user during the present lock state are rolled back and undone. The commit/rollback processing module 270 can command the rollback of all database changes made by the user between the time of the initiation of the lock state to just before the commit/rollback processing module 270 performs the rollback operation. After a rollback operation has completed, the state of the affected database table is the same as the state just prior to the initiation of the lock state. In other words, the database table has the same contents after the rollback as just before the locking of the table, and the system discards the changes the user entered during the lock state as though they had never been entered.

Another way the commit/rollback processing module 270 terminates the lock state is to commit the transaction. If the user elects to accept the changes made during the period of locking a record, the user indicates a request for the commit operation. The commit/rollback processing module 270, upon receiving the commit request, sends a commit command to the persistent storage device 140 and to the volatile storage database system 160. A commit can be thought of as an accept operation, as the commit/rollback processing module 270 commands the persistent storage device 140 and the volatile storage database system 160 to accept and enter into the database any and all changes made during the present lock state. After the commit operation has completed, the contents of the affected database record are modified as compared to the contents just prior to the initiation of the lock state and the previous contents are overwritten.

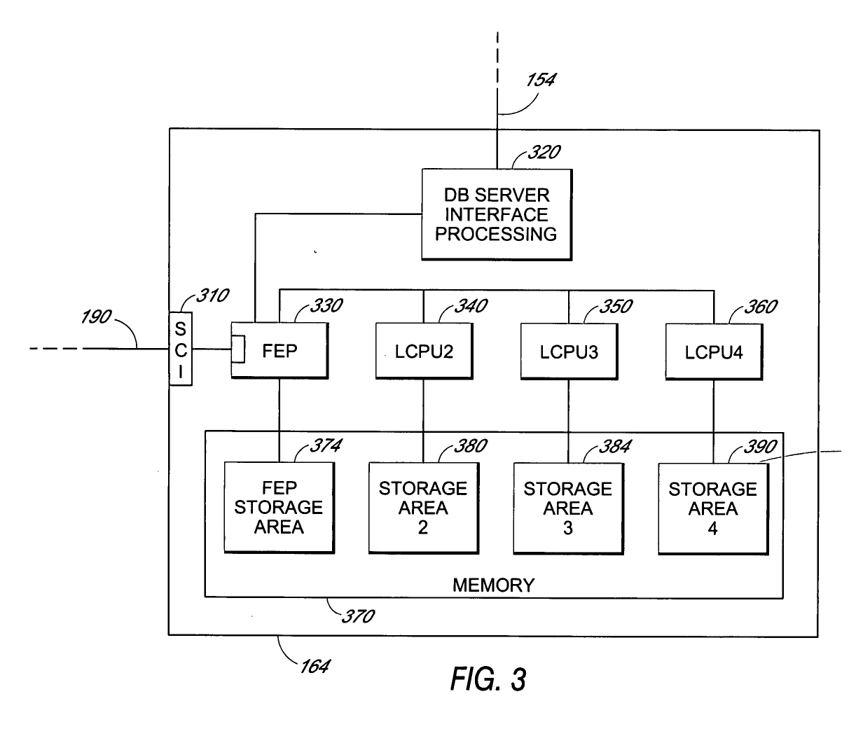

FIG. 3 is a block diagram of the primary node 164 of the volatile storage database system 160 shown in FIG. 1. Except as noted, all of the nodes 1-N operate in the same manner and include the same elements. Therefore, the other nodes will not be described in detail. Each node can be a processor with main memory. Alternatively, each node can be a computer with a main memory, which can be segmented in multiple sections as shown in FIG. 3.

A significant portion of the database storage and retrieval can be shared by the nodes, thereby spreading the processing load substantially equally among the nodes. The database storage and retrieval can be performed in a substantially parallel fashion by the nodes, thereby significantly increasing the performance of the volatile storage database system 160. In addition, the volatile storage database system 160 is easily expandable when additional performance is desired by simply adding nodes.

The primary node 164 includes a database server interface processing module 320 that communicates with the DB server 130 via the communication link 154. The database server interface processing module 320 transmits and receives data between the primary node 164 and the DB server 130 in conformance with the applicable communication protocol. The data received from the DB server 130 includes database commands, and the transmitted data includes the results of database query commands.

The primary node 164 communicates with the other nodes that are present in the volatile storage database system 160 via a communication link interface module 310 and the inter-nodal communication link 190. In some embodiments, the inter-nodal link 190 and the communication link interface module 310 conform to the Scalable Coherent Interface (SCI) protocol as specified by the Institute of Electrical and Electronics Engineers (IEEE) 1596 standard. Other communication interface links can also be used for the inter-nodal communication of the nodes 164, 170, 174, 180 in the volatile storage database system 160. For example, the inter-nodal link 190 can be fiber optic, Ethernet, small computer system interface (SCSI), VersaModule Eurocard bus (VME), peripheral component interconnect (PCI), or universal serial bus (USB).

The primary node 164 includes at least one processor 326 for performing the operations of the primary node 164. The processor 326 can be a general-purpose single- or multi-chip processor, or a special purpose processor such as an application specific integrated circuit (ASIC). The processor 326 can include at least one physical processor and at least one logical processing unit. For example, in some embodiments, the processor 326 can include two or more physical processors (not shown) for performing the operations of four logical processing units. The four logical processing units shown in FIG. 3 are a front-end processor (FEP) 330, a logical central processing unit (LCPU2) 340, a logical central processing unit (LCPU3) 350, and a logical central processing unit (LCPU4) 360. In this example, the FEP 330 and the LCPU2 340 can be executed by one physical processor, and the LCPU3 350 and LCPU4 360 can be executed by a second physical processor. The FEP 330 communicates with the DB server 130 through the database server interface processing module 320. Other configurations of physical processors and logical processing units, for example, with more or fewer physical processors and logical processing units, are also possible.

The logical CPUs 340, 350, 360, also referred to as Tstores, store a portion of the database information and respond to database queries. The Tstores additionally make available their join tables loin tables are those records in a table that match the search criteria) to other Tstores in response to database queries, receive join tables from other Tstores, and build results files.

The LCPU2 340, the LCPU3 350, and the LCPU4 360 are designated as logical processing units to indicate that each can execute on a separate physical CPU, or that multiple logical CPUs can execute on a single physical CPU. FIG. 3 shows the FEP 330 communicating with the communication link interface module 310 to transmit and receive data via the inter-nodal communication link 190. Alternatively, the primary node 164 can also be configured so that any of the logical processing units LCPU2 340, LCPU3 350, LCPU4 360 communicate with the communication link interface module 310 in place of the FEP 330.

As shown in FIG. 3, the FEP 330 and each of the logical CPUs LCPU2 340, LCPU3 350, LCPU4 360 have an associated storage area in a memory 370 of the node 164. In some embodiments, the link between the processors 326 and the memory 370 can be the main bus of the processor, which provides high-speed data access. The FEP 330 stores data in an FEP storage area 374. The LCPU2 340 stores data in a storage area 2 380. The LCPU3 350 stores data in a storage area 3 384. The LCPU4 360 stores data in a storage area 4 390. The FEP storage area 374, storage area 2 380, storage area 3 384, and storage area 4 390 are shown in FIG. 3 as separate, non-contiguous, non-overlapping areas for ease of illustration. However, the actual physical location of the FEP storage area 374, the storage area 2 380, the storage area 3 384, and the storage area 4 390 may be contiguous or may overlap. Alternatively, there can be fewer or more data storage areas than those shown in FIG. 3. For example, there can be only one storage area that is shared by all the processors, or each processor may have multiple storage areas. Typically, the memory 370 is random access memory (RAM) such as static RAM (SRAM) or dynamic RAM (DRAM). However, other types of data storage can be utilized, for example, flash memory or read-only memory (ROM).

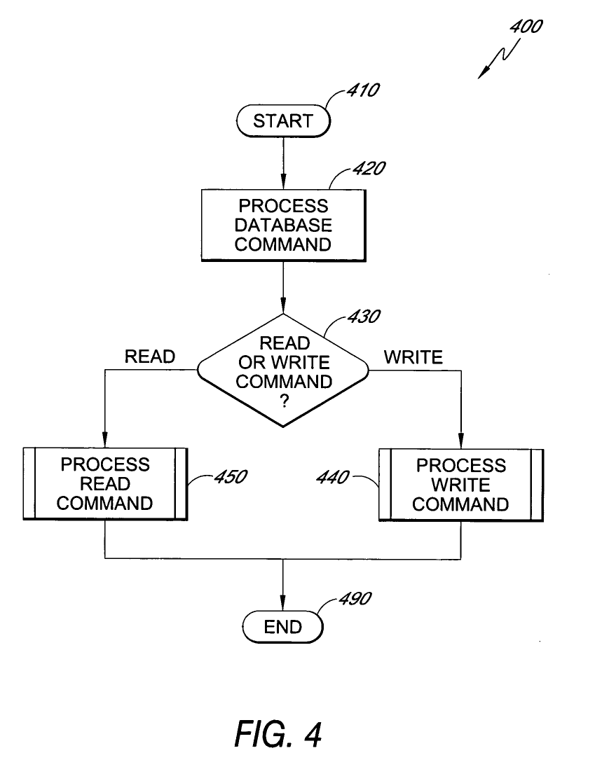

FIG. 4 is a flowchart illustrating a database command process 400 as performed by the database command processing module 240 shown in FIG. 2. The database command process 400 performs the database command received by the DB server 130 from the user at the client computer system 110. The database command process 400 begins at a start block 410. The database command process 400 continues at a block 420 for processing a database command, for example, a read or write command. Examples of the database commands include a read command, for example, a query, and a write command, for example, an update of an existing record, a delete of an existing record, a create of a new record, or a create of a new table. The database command processing at the block 420 can include determining the particular command and parsing the command parameters that may be included with the command. Command parameters typically vary from command to command, and can include a table name, a field name, a field match parameter, or other search parameter.

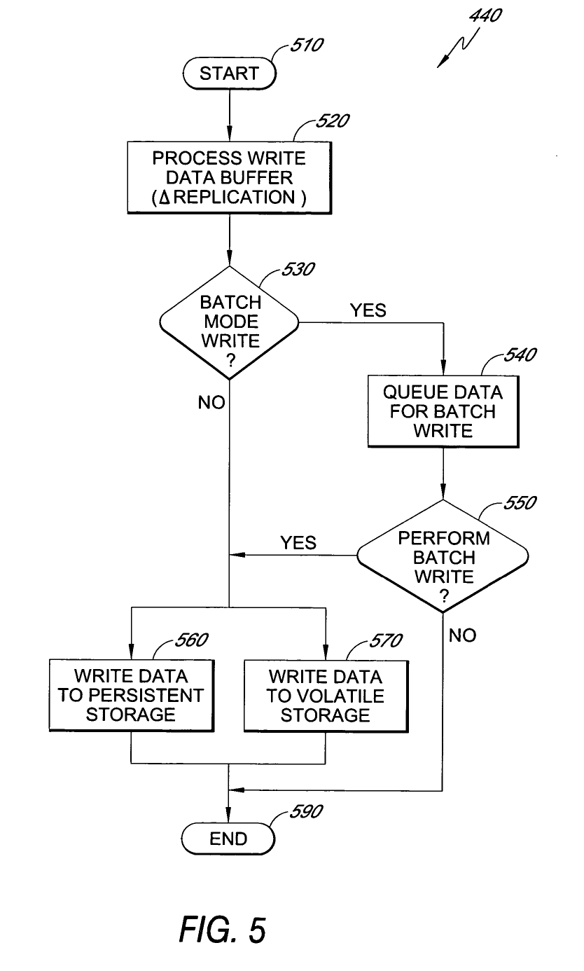

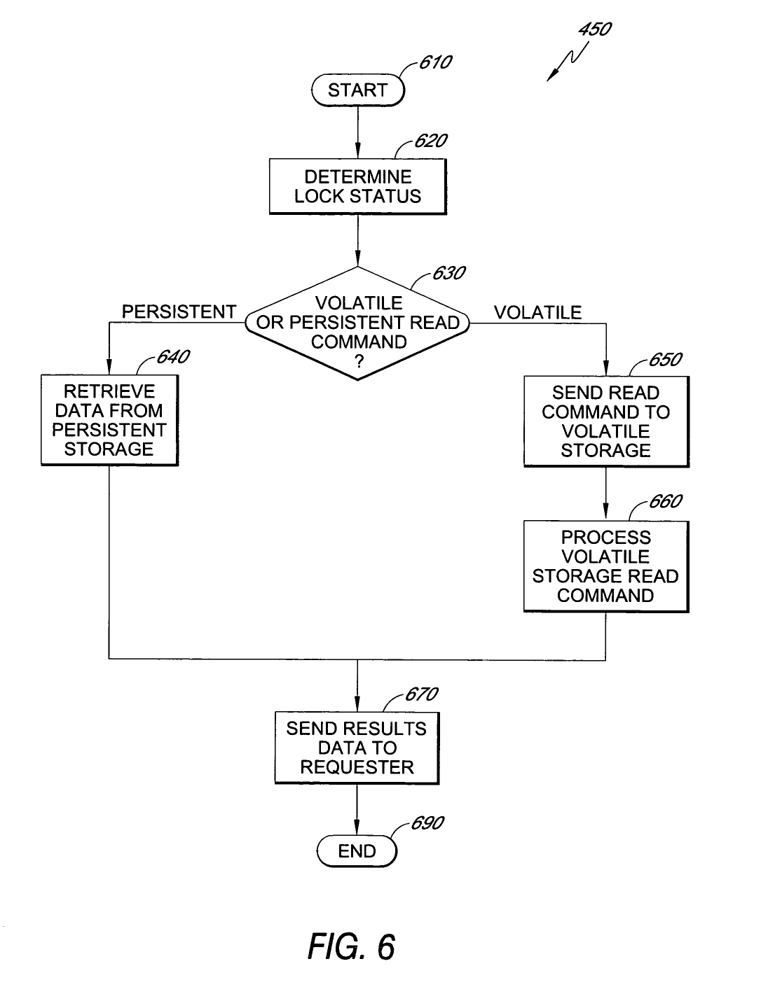

The database command process 400 continues at a decision block 430 for determining whether the current database command is a read command or a write command. If the database command process 400 determines at the decision block 430 that the command is a read command, the database command process 400 continues at a block 450 for processing the read command as performed by the database command processing module 240 and views processing module 260. An example of the process read command block 450 is illustrated in FIG. 6 and described in greater detail below. If the database command process 400 determines at the decision block 430 that the command is a write command, the database command process 400 continues at a block 440 for processing the write command as performed by the database command processing module 240 and the trigger processing module 250. An example of the process write command block 440 is illustrated in FIG. 5 and described in greater detail below. Regardless of whether the database command is a read or a write command, the database command process 400 terminates at an end block 490.

FIG. 5 is a flowchart illustrating a database write command process 440 as performed by the database command processing module 240 and the trigger processing module 250 shown in FIG. 2. The database write command process 440 performs the actual writing of the desired data to the persistent storage device 140 and the volatile storage database system 160. The database write command process 440 begins at a start block 510. The database write command process 440 continues at a block 520 for processing the write command. The block 520 is performed by the database command processing module 240. The write command can include parameters that further specify the write command. These parameters can include the particular write command to be performed, for example, create a new record, delete an existing record, or update the data in a field in an existing record. In addition, these parameters can include the table name or field name to write to or the actual data to write to the database. The update write commands can be referred to as delta replication commands, in that only the changed data is written to the persistent storage device 140 and the volatile storage database system 160, and the unchanged data is not altered or overwritten.

Alternatively, in other embodiments, coherency or synchronization between databases is not maintained at all times. For example, the databases may never by synchronized and all database write commands are directed to the volatile storage database system 160. In this example, the persistent storage device 140 is for historical purposes. In another example, the databases are synchronized only at certain times, such as at night when most or all of the users are typically away from work and not using the system. In this example, the database write commands are directed to the volatile storage database system 160, and at certain times either the changes or the entire database are written to the persistent storage device 140. In yet another example, the database write commands are directed to the persistent storage device 140 and the volatile storage database system 160 does not get updated at all, or just at certain times. In the examples where the databases are not synchronized at the time of the database write command, the database write commands do cause the update or synchronization to occur at some later time.

The database write command process 440 continues at a decision block 530 for determining whether the write command is a batch mode write command. As described above, batch write commands can be stored or queued up for a period of time and then executed one after another at a later time. For example, a series of write commands can be stored in memory and executed at some later time, or write data and destination information can be stored in memory for later processing. If the process 440 determines at the block 530 that the command is a batch mode write command, the process 440 continues at a block 540 for queuing the data for the batch write command, for example, by storing the write commands in memory. The database write command process 440 continues at a decision block 550 for determining whether it is time for execution of the batch write commands to cause the data to be written to the database. The blocks 530, 540, 550 are performed by the database command processing module 240. If the process 440 determines at the decision block 550 that it is not time to perform the batch write command, the process 440 terminates at an end block 590.

If, however, the process determines at the decision block 550 that it is time to perform the batch write command, or if the process 440 determines at the decision block 530 that the command is not a batch mode write command, the process 440 continues at parallel blocks 560, 570. At the block 560, which is performed by the trigger processing module 250, the process 440 writes the data to the persistent storage device 140. At the block 570, also performed by the trigger processing module 250, the process 440 send the write data to the primary node 164 of the volatile storage device 160. The blocks 560, 570 are shown in FIG. 5 as parallel execution blocks to illustrate that the process 440 can write data to either the persistent storage device 140 or the volatile storage database system 160, or both. Whether the data is written to persistent storage, volatile storage, or both is determined by the views processing module 260 (see FIG. 2).

Data is written to the persistent storage device 140 for reliable and long-term data storage, and to the volatile storage device 160 for high-speed data retrieval. By writing data to both the persistent storage device 140 and the volatile storage device 160 in a parallel fashion, the accelerated database system 105 is able to provide both reliable, long-term storage and high-speed retrieval capabilities. After writing the data to the designated database storage device in the blocks 560, 570, the process 440 terminates at an end block 590.

FIG. 6 is a flowchart illustrating a database read command process 450 as performed by the database command processing module 240 and views processing module 260 of FIG. 2. Database read commands are also referred to as database query commands, which can include requests for matches in multiple fields in multiple tables. The database read command process 450 begins at a start block 610. The database read command process 450 continues at a block 620 for determining the lock status of the record or records being accessed by the particular read command. The block 620 is performed by the database command processing module 240. The read command process 450 continues at a decision block 630, which is performed by the views processing module 260, to determine whether the read command is to read data from the volatile storage database system 160 or from the persistent storage device 140.

As described above with regard to FIG. 2, the database read commands can be directed to particular database systems by the views processing module 260. The views processing module 260 allows for redirection of database read commands, such that read commands that originally were directed to the persistent storage device 140 can be redirected to the faster volatile storage database system 160 by merely changing a views table. In this way, existing database systems that only store data on a single type of database, for example, a persistent database, can be migrated to the accelerated database system 105 with minimal effort involving modification of the views table. Alternatively, the views processing module 260 accepts a prefix appended to the table name and determines the destination database storage device or devices associated with the prefix by reference to the views table.

If the read command process 450 determines at the block 630 that the read command is to the persistent storage device 140, the process 450 continues to a block 640 to retrieve the data from the persistent storage device 140. The processing at the block 640 can include a standard database protocol read command, for example, the “SELECT” SQL command. For the purposes of example, suppose the following database table has been created with the table name “Employees” and populated with three records.

| ID | LastName | Age |
|---|---|---|
| 1 | Johnson | 48 |
| 2 | Peterson | 32 |
| 3 | Miller | 39 |

The SQL read command “SELECT LastName FROM Employees WHERE Age<40” would return “Peterson” and “Miller” in this simple example. While countless other examples are also possible, this example illustrates a simple SQL read command. In other examples, the table name could be prefixed to direct the read specifically to the persistent storage device 140 as described above. Modifying the above example in this way, the read command would be of the form “SELECT LastName FROM P1.Employees WHERE Age<40.”

If the read command process 450 determines at the block 630 that the read command is to the volatile storage database system 160, the process 450 continues to a block 650 to send the read command to the volatile storage database system 160. The processing at the block 650 can include transmitting the read command to the primary node 164 via the communication link 154. In such embodiments, the primary node 164 receives the read command at the block 650, and if the requested data is not stored on the primary node 164, forwards it to the secondary nodes 170, 174, 180 for processing by transmitting a broadcast message over the inter-nodal communication link 190. One example of the operation of the primary node 164 and the secondary nodes 170, 174, 180 is described in greater detail in the copending U.S. patent application titled “SYSTEM AND METHOD FOR DISTRIBUTED DATABASE PROCESSING IN A CLUSTERED ENVIRONMENT” (Attorney Docket No. XP.002CP1), filed on even date herewith. The process 450 continues to a block 660 to process the read command at the volatile storage database system 160 and return the search results as described above.

From the block 640 and the block 660, the process 450 continues to a block 670 to send the search results from the primary node 164 to the DB server 130 via the communication link 154. The DB server 130 transmits the retrieved data to the requesting user on the client computer system 110 via the network 120. The process 450 terminates at an end block 690.

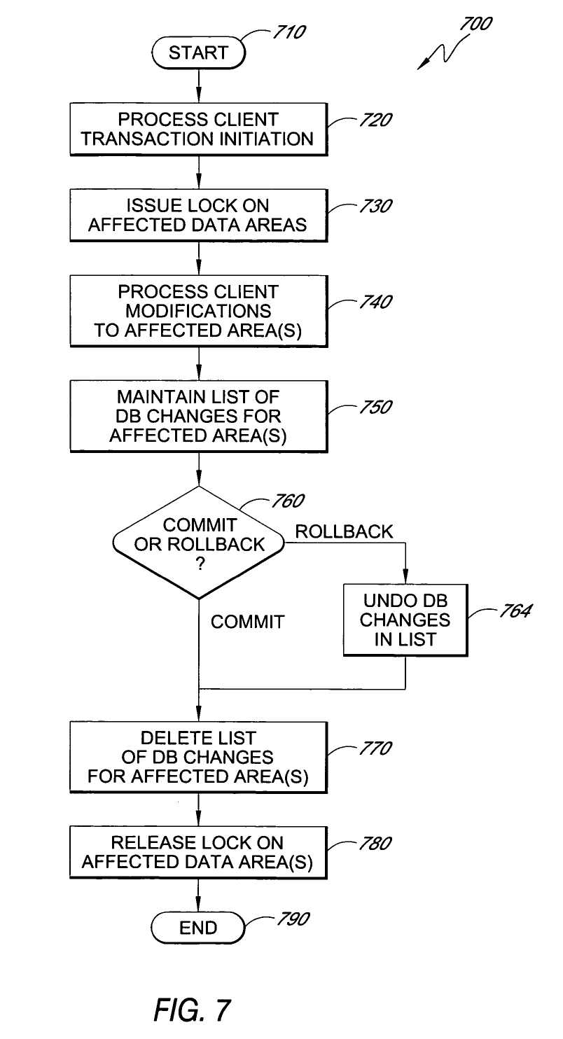

FIG. 7 is a flowchart illustrating a commit/rollback process 700 as performed by the commit/rollback processing module 270 shown in FIG. 2. As described above, the commit/rollback process 700, also referred to as the two phase commit process, maintains data integrity and accuracy within database systems through synchronized locking and updating of all segments of a database transaction. The commit/rollback process 700 begins at a start block 710. The commit/rollback process 700 continues at a block 720 for processing client initiation of the two phase commit transaction. The processing at the block 720 includes parsing the command and any accompanying command parameters, and identifying the affected data tables or records. The commit/rollback process 700 continues at a block 730 to issue a lock command of the affected data tables or records identified in the block 720. Once the lock is in place for the affected data areas, the locked data cannot be accessed during the period that the lock is in effect.

The commit/rollback process 700 continues at a block 740 for processing client modifications to the affected data area. Typically, the client modifications are stored in a temporary location of computer memory, as the database area cannot be updated while the area is locked. The commit/rollback process 700 continues at a block 750 for maintaining a list of database changes for the affected database areas, for example, in the temporary memory location. In some embodiments, the processing at the block 750 is performed by the volatile storage database system 160, for example, by the FEP 330 at the nodes or by the individual Tstores. The commit/rollback process 700 continues at a decision block 760 for determining whether the user has selected to commit to the changes and have the changes entered in the database, or to rollback (undo) the changes.

If the commit/rollback process 700 determines at the decision block 760 that the user selected to rollback the changes, the commit/rollback process 700 continues to a block 764 to undo the database changes in the list. In some embodiments, the processing at the block 750 is performed by the volatile storage database system 160, for example, by the FEP 330 at the nodes or by the individual Tstores. When the undo processing of the block 764 has been performed, the locked database area remains unchanged as compared to the affected database area just prior to the initiation of the lock command. If the commit/rollback process 700 determines at the decision block 760 that the user selected to commit the changes, or after execution of the undo block 764, the commit/rollback process 700 continues to a block 770 to delete the list of database changes for the affected area. Having either committed to the entry of the database changes or rolled back the changes, the database changes no longer need to be maintained in the list. Thus, the list can be deleted at the block 770.

The commit/rollback process 700 continues to a block 780 to release the lock on the affected data area. Once the changes are accepted (committed) or rejected (rolled back), the lock is released and the affected database area is once again available to be accessed by the users of the database system 100. The commit/rollback process 700 terminates at an end block 790.

While the above detailed description has shown, described, and pointed out novel features of the invention as applied to various embodiments, it will be understood that various omissions, substitutions, and changes in the form and details of the device or process illustrated may be made by those of ordinary skill in the technology without departing from the spirit of the invention. This invention may be embodied in other specific forms without departing from the essential characteristics as described herein. The embodiments described above are to be considered in all respects as illustrative only and not restrictive in any manner. The scope of the invention is indicated by the following claims rather than by the foregoing description.

What is claimed is:

1. An accelerated database system comprising:
a persistent storage device configured for continuous storage of a table of data;
a volatile storage database system comprising a processor and a volatile main memory, said volatile storage database system is configured for concurrent storage and high-speed retrieval of said table of data; and
a database server in communication with said persistent storage device and said volatile storage database system, said database server is configured to receive a database write command and send a corresponding write command to said persistent storage device and to said volatile storage database system, and is additionally configured to receive a database read command requesting data and to retrieve the requested data from said volatile storage database system.

2. The system of claim 1, wherein said volatile storage database system comprises a plurality of processors, wherein each processor communicates with each other processor for distributing said database write command among the processors and for returning results data from said database read command.

3. The system of claim 1, further comprising a client computer system in communication with said database server, wherein said client computer system is configured to generate said database read command and said database write command in response to a user action and transmit said database read command and said database write command to said database server.

4. The system of claim 1, wherein said persistent data storage device is a hard disk drive.

5. The system of claim 1, wherein said database server is a standard query language (SQL) compliant database server.

6. The system of claim 1, wherein said volatile storage database system comprises random access memory for storage of said table of data associated with said database write command.

7. The system of claim 1, wherein said database read command and said database write command comprise a name of said table of data, and wherein said name comprises a prefix that designates a destination of said database read command and said database write command to either said persistent data storage device or said volatile storage database system.

8. The system of claim 1, wherein said processor is configured to perform commit processing by maintaining a list of changes to said table of data and further configured to perform rollback processing by undoing said list of changes.

9. The system of claim 1, wherein said database server is configured to send said corresponding write command only to said volatile storage database system.

10. The system of claim 1, wherein said database server is configured to send said corresponding write command only to said persistent storage device.

11. A cooperative database server system for distributing a database write command to a persistent storage device and to a volatile storage database system, and for distributing a database read command to the volatile storage database system, the system comprising:
a network interface processing module configured to receive a database command via a network and transmit data related to said database command over said network, wherein said database command comprises a read command and a write command, and wherein said read command and write command comprise a database table name;
a trigger processing module configured to receive said write command and generate a trigger in response to said write command, wherein said trigger comprises execution of instructions that transmit said write command to a persistent storage device and to a volatile storage database system; and
a views processing module configured to receive said read command and direct said read command to said volatile storage database system.

12. The system of claim 11, further comprising a commit/rollback processing module configured to:
commit a modification to a database record by accepting said modification to said database record; and
undo said modification to said database record by restoring said database record to its previous contents.

13. The system of claim 12, wherein said commit/rollback processing module is further configured to lock said database record during said modification of said database record.

14. The system of claim 13, wherein said lock of said database record is released upon completion of said modification of said database record.

15. The system of claim 11, further comprising a primary node interface processing module in communication with said volatile storage database system and configured to transmit said database command to said volatile storage database system and receive data from said volatile storage database system in response to said read database command.

16. The server system of claim 11, further comprising a database command processing module configured to receive said database command from said network interface processing module and generate a corresponding database server command from said database command.

17. The system of claim 11, wherein said trigger processing module is further configured to transmit said write command in a batch processing mode.

18. The system of claim 11, wherein directing said read command is to either said persistent storage device or to said volatile storage database system according to said database table name.

19. The system of claim 11, wherein said trigger comprises execution of instructions that transmit said write command to said persistent storage device and to said volatile storage database system at different times.

20. A method of storing and retrieving a table of data from an accelerated database system, the method comprising:
storing a table of data on a persistent storage device, said persistent storage device is configured for continuous storage of said table of data;
storing said table of data concurrently on a volatile storage database system, said volatile storage database system is configured for storage and high-speed retrieval of said table of data;
receiving a database write command and sending a corresponding write command to said persistent storage device and to said volatile storage database system;
receiving a database read command requesting data; and
retrieving the requested data from said volatile storage database system.

21. The method of claim 20, further comprising distributing said database write command among a plurality of processors of said volatile storage database system.

22. The method of claim 20, further comprising returning results data from said database read command.

23. The method of claim 20, further comprising generating said database read command and said database write command in response to a user action and transmitting said database read command and said database write command via a network.

24. The system of claim 20, wherein said persistent data storage device is a hard disk drive.

25. The system of claim 20, wherein said database read command and said database write command are standard query language (SQL) compliant commands.

26. The system of claim 20, wherein said volatile storage database system comprises random access memory for storage of said table of data associated with said database write command.

27. The system of claim 20, wherein said database read command and said database write command comprise a name of said table of data, and wherein said name comprises a prefix that designates a destination of said database read command and said database write command to either said persistent data storage device or said volatile storage database system.

28. The system of claim 20, wherein storing said table of data on said volatile storage database system is performed at a different time than storing said table of data on said persistent storage device.

29. The system of claim 20, wherein sending said corresponding write command to said persistent storage device and to said volatile storage database system are performed at different times.

30. A method of distributing a database write command to a persistent storage device and to a volatile storage database system and distributing a database read command to the volatile storage database system, the method comprising:
receiving a database command via a network, wherein said database command comprises a read command and a write command, and wherein said read command and said write command comprise a database table name;
transmitting data related to said database command over said network;
receiving said write command;
generating a trigger in response to said write command, wherein said trigger comprises execution of instructions that cause a persistent storage device and a volatile storage database system to be updated according to said database table name and said data related to said database command;
receiving said read command; and
directing said read command to said volatile storage database system.

31. The method of claim 30, further comprising:
committing a modification to a database record by accepting said modification to said database record; and
undoing said modification to said database record by restoring said database record to its previous contents.

32. The method of claim 31, further comprising locking said database record during said modification of said database record.

33. The method of claim 32, further comprising unlocking said database record upon completion of said modification of said database record.

34. The method of claim 30, further comprising receiving results data from said volatile storage database system in response to said read command.

35. The system of claim 30, wherein said transmitting of said write command is performed in a batch processing mode.

36. The system of claim 30, wherein directing said read command is to either said persistent storage device or to said volatile storage database system according to said database table name.

37. The system of claim 30, wherein said transmitting said write command to said persistent storage device and to said volatile storage database system are performed at different times.
